(19) United States
(12) Patent Application Publication
(10) Pub. No.: US 2005/0055404 A1
(43) Pub. Date: Mar. 10, 2005

(54) E-mail server registry and method

(75) Inventor: W. Doyle Kitchen JR., Dallas, TX (US)

Correspondence Address: Steven W. Smith;Attorney at Law, 7237 Birchwood Drive, Dallas, TX, 75240, US

(73) Assignee: Information Processing Corporation

(21) Appl. No.: 10/655,324

(22) Filed: Sep. 4, 2003

(51) Int. Cl. G06F 15/16

(52) U.S. Cl. 709/206

(57) ABSTRACT

A system for denying or allowing delivery of an incoming electronic mail (e-mail) message that indicates a source e-mail server, source domain, and an addressee for the message. A central e-mail server registry database stores information for all e-mail servers authorized to send e-mail messages over the Internet. Each e-mail recipient can specify characteristics of domains that are authorized to send e-mail messages to the recipient. When an incoming e-mail message arrives at the recipient's e-mail server, the server accesses the registry database to determine whether the source e-mail server and/or domain are registered, and if so, whether the registration in good standing, and whether the source domain possesses the specified characteristics. If these conditions are not met, delivery of the e-mail is denied. Registered e-mail servers can download specified server information from the central registry and store it in a local registry. When incoming messages arrive at the server, the local registry is checked first, if unsuccessful, the central registry is checked.

### BACKGROUND OF THE INVENTION

1. Technical Field of the Invention

This invention relates to the delivery of electronic mail (e-mail) messages. More particularly, and not by way of limitation, the invention is directed to an e-mail server registry that enables e-mail servers and/or front-end processors to determine whether an incoming e-mail is indeed from the source described in its header, and that e-mails from the source are acceptable for their recipients.

2. Description of Related Art

The Internet is a vast composition of computing resources, many of which are computers that send electronic mail (e-mail). Billions of e-mail message are sent on a daily basis in the United States, and estimates are that up to 40 percent of these e-mail message are unwanted and unsolicited messages, commonly referred to as “SPAM”. A typical e-mail user receives unwanted e-mail from both companies and individuals. In many instances, the people that receive these unsolicited e-mail messages are at work, and are using company time and resources to delete, set up filters, and sometimes read this e-mail. In almost all cases, the companies wish to block e-mails that are pornographic, have no applicability to their business, or occupy their workers' time away from doing their job.

An e-mail server is a computer that has an associated Internet Protocol (IP) address used for sending and receiving e-mail over the Internet. A front-end processor may be utilized to interface with the Internet and to sort and distribute e-mail messages to one or more e-mail servers. Thus, the term “e-mail server”, when used herein refers to the actual server and any associated front-end processor. Companies either set up e-mail servers for their own use, or in the case of Information Technology (IT) processors and Internet Service Providers (ISP's), they set up e-mail servers for the business of their customers. Governments also set up and operate e-mail servers for the use of their citizens to contact the government, and all of these servers are being inundated by illegal e-mails selling everything from pornography to weight loss solutions. These e-mails are not coming from company business partners, relatives, or friends of workers, or from citizens trying to contact the government. In many cases, the e-mails originate in rogue servers that are not associated with companies, but with an individual who has bought an e-mail list and sends SPAM e-mails that waste time and resources. The sheer volume of SPAM and unwanted e-mail costs corporate America, federal, state, and local governments billions of dollars each year in wasted computing resources and personnel time.

Blocking of unsolicited electronic mail has traditionally been handled with filters, open relay lists, white lists, and black lists. Filters, though somewhat effective, still do not catch all unwanted e-mail. An additional problem with filters is that desirable e-mail may also be blocked. This occurs when filters block e-mail by searching for words or phrases in the body of the text of each e-mail. This leads to blocking e-mails, for example, from spouses, co-workers, business partners, doctors, lawyers, or other sources. The combination of filters and lists can be effective to a certain extent, but still cannot identify and certify that the e-mail has come from a legitimate source.

In order to overcome the disadvantages of existing solutions, it would be advantageous to have an e-mail server registry and corresponding method of enabling e-mail servers to determine whether an incoming e-mail is indeed from the source described in its header, and that e-mails from the source are acceptable for their recipients. The present invention provides such a registry and method.

### SUMMARY OF THE INVENTION

In one aspect, the present invention is directed to a system for denying or allowing delivery of an incoming electronic mail (e-mail) message that indicates a source e-mail server, a source domain, and an addressee for the message. The system includes a central e-mail server registry database for storing information regarding all e-mail servers and domains authorized to send e-mail messages over the Internet; means for the addressee to specify characteristics of domains that are authorized to send e-mail messages to the addressee; and means for an e-mail server serving the addressee to access information from the registry database to determine whether the source domain possesses the specified characteristics. The system also includes means for allowing delivery of the incoming e-mail message if the source domain possesses the specified characteristics, and denying delivery of the incoming e-mail message if the source domain does not possess the specified characteristics. The means for allowing delivery and denying delivery of the incoming e-mail message may also deny delivery if the source e-mail server and/or source domain are not registered with the central registry database, or if the registrations of the source e-mail server and/or source domain are not in good standing.

In another aspect, the present invention is directed to a method of denying or allowing delivery of an incoming e-mail message that indicates a source e-mail server, a source domain, and an addressee for the message. The method includes the steps of storing in a central e-mail server registry database, information regarding all e-mail servers and domains authorized to send e-mail messages over the Internet; specifying for the addressee, characteristics of domains that are authorized to send e-mail messages to the addressee; receiving the incoming e-mail in an e-mail server serving the addressee; and accessing by the e-mail server serving the addressee, information from the central registry database. The method also includes determining whether the source domain possesses the specified characteristics; allowing delivery of the incoming e-mail message if the source domain possesses the specified characteristics; and denying delivery of the incoming e-mail message if the source domain does not possess the specified characteristics.

In yet another aspect, the present invention is directed to an e-mail server registry that includes means for registering e-mail servers and domains authorized to send e-mail messages over the Internet; an e-mail server registry database for storing information regarding the registered e-mail servers and domains; and means for responding to queries from registered e-mail servers regarding other e-mail servers and/or domains. The means for responding to queries may include means for determining whether an identified e-mail server and/or domain is registered, whether the identified e-mail server and/or domain is registered in good standing, and whether the identified domain meets defined criteria regarding the country, industry, and business class of the identified domain.

In still yet another aspect, the present invention is directed to a system for denying or allowing delivery of an incoming e-mail message that indicates a source e-mail server and an addressee for the message. The system includes a central e-mail server registry database for storing registration information for all e-mail servers authorized to send e-mail messages over the Internet; means for an e-mail server serving the addressee to query the registry database to determine whether the source e-mail server is registered in the registry database; and means for allowing delivery of the incoming e-mail message if the source e-mail server is registered in the registry database, and denying delivery of the incoming-e-mail message if the source e-mail server is not registered in the registry database.

In still yet another aspect, the present invention is directed to a system for denying or allowing delivery of an incoming e-mail message that indicates a source e-mail server, a source domain, and an addressee for the message. The system includes an e-mail server serving the addressee; and a local e-mail server registry database associated with the e-mail server serving the addressee. The local registry database stores information for a subset of all e-mail servers and domains authorized to send e-mail messages over the Internet. The system also includes means for the addressee to specify characteristics of domains that are authorized to send e-mail messages to the addressee; means for the e-mail server serving the addressee to access information from the local registry database to determine whether the source domain possesses the specified characteristics; and means within the e-mail server serving the addressee for allowing delivery of the incoming e-mail message if the source domain possesses the specified characteristics, and denying delivery of the incoming e-mail message if the source domain does not possess the specified characteristics, or if the source domain is not included in the local registry database.

### BRIEF DESCRIPTION OF THE DRAWINGS

A more complete understanding of the present invention may be had by reference to the following Detailed Description when taken in conjunction with the accompanying drawings wherein:

FIGS. 1A-1C are portions of a flow chart illustrating the steps of the preferred embodiment of the e-mail Registry method of the present invention;

FIG. 2 is a simplified block diagram illustrating the communications between Registry servers primarily operating in different countries and exchanging Registry entries;

FIG. 3 is a message flow diagram illustrating the flow of messages between a registered e-mail server and a Registry server during download procedures to update the registered e-mail server's local directory of registered servers;

FIG. 4 is a simplified block diagram of networked e-mail servers on the Internet accessing the Registry; and

FIGS. 5A-5E are portions of a flow chart illustrating the download procedures between a Registry server and an e-mail server or another computer that provides a local registry database for processing.

### DETAILED DESCRIPTION OF EXEMPLARY EMBODIMENTS

The present invention provides a system, methodology, and software to create and operate an E-mail Registry Service (hereinafter referred to as the “Registry”). The Registry is a “Web Service” that is provided to companies to authenticate the sources of e-mail messages arriving in their e-mail servers. The e-mail servers may be configured to receive messages based upon a Registry class, status, and industry field of the source domain included in the incoming e-mail messages.

The Registry provides a database of registered users, which functions as a centralized repository of information on each registered e-mail server and the domains that operate within. The database is shared, and computer readable code is separated from internal e-mail servers in order to enable usage of the database in all computing environments. When a company is registered, the company can then access the services of the Registry from the company's registered e-mail servers. The Registry only acknowledges messages from registered servers.

The Registry provides the requesting e-mail server with validation that the source of an incoming e-mail is a registered e-mail server and domain, and provides additional information on the source domain's country, class, and industry. E-mails from source e-mail servers and/or domains that are not registered, or from domains that are not of a designated country, class, or industry, are not delivered to the destination e-mail server. For example, a registered user may designate that he does not want to receive any e-mails from domains having a “Retail Sales” class. A registered user may also designate that he only wants to receive e-mails from Corporate Business domains. This provides companies with the ability to define what types of e-mail enter their servers, allowing them to eliminate e-mail from sources that are not applicable to their daily business.

The class of an e-mail domain is a field returned to the requesting e-mail server that defines the class of business that the source corporation provides. Class is defined at the domain level. The following is a list of exemplary classes defined by the Registry and is not to be considered inclusive:

Corporate Business. This class defines a domain that does not originate messages that contain advertisements or solicitations. This class is used for corporate business only with its employees or business partners.

Retail Sales. This class defines a domain that sends solicitations for the purpose of retail sales.

Corporate Sales. This class defines a domain that sends solicitations for the purpose of product sales to other business entities (not to individual consumers).

Corporate Professional Services. This class defines a domain that sends solicitations for the purpose of advertising its services to other businesses.

Consumer Professional Services. This class defines a domain that sends solicitations for the purpose of advertising its services to individual consumers.

Other classes may include, for example, political groups, governmental entities, educational entities such as universities or other “.edu” domains, adult entertainment businesses, family entertainment businesses, gambling businesses, travel industry businesses, and the like.

The status of an e-mail domain is a field returned to the requesting e-mail server that provides the current registration status of the originating server and/or domain. Possible statuses are:

Unregistered Server

Unregistered Domain

Good

Review (open complaints)

Suspended

The industry of an e-mail domain is a field indicating the industry in which the registrant business operates. Standard Industry Codes (SIC) as defined by the Occupational Safety & Health Administration (OSHA) of the United States Department of Labor may be utilized, but are not preferred because, in many cases, they are too detailed. In one embodiment, the present invention utilizes industry codes as defined by the North American Industry Classification System because these codes provide both generalized and detailed codes.

To obtain entry into the Registry, a company must provide information about its business and its use of e-mail communications. A company can register multiple e-mail servers, each having multiple associated domains, and domains of different class, status, and industry designations. An individual cannot register. Each registrant must have a Federal Tax Identification Number (in the United States) or international equivalent that identifies the registrant as a legitimate business operating in the country of origin.

The Registry enables registered e-mail servers to notify the Registry electronically of e-mail from registered e-mail servers and domains that are sending SPAM or suspected violations of the service class. If an e-mail from a registered e-mail server/domain does not pass the company's SPAM filter, the e-mail can be sent to the Registry for review. The Registry reviews all suspect messages received by its members to determine whether the originating server/domain, if registered, should be suspended. Once a verified suspect message is received about a registered server, the server owner and the domain owner are notified. The status of the suspect server/domain is changed from “Good” status to “Review”. If the questionable practice does not cease within 72 hours after notification from the Registry, the server/domain status is changed to “Suspended”. Once a server/domain entry is “Suspended”, the status can only be changed if the domain registrant accepts fines for each instance of additional suspect e-mails or SPAM that originates from the suspended server. If this condition is accepted, then the suspect server/domain is placed in “Review” status again for one week. If no further complaints occur for the review period, then the server regains a “Good” status within the Registry.

Regardless of the servers being utilized by a domain, if the domain has excessive infractions, the domain is suspended without the ability for renewal. Once a server is in “Suspended without renewal” status, the server's Internet Protocol (IP) address is not honored until another corporate entity applies for registration and can prove that it is not associated with the previous owner of that IP address.

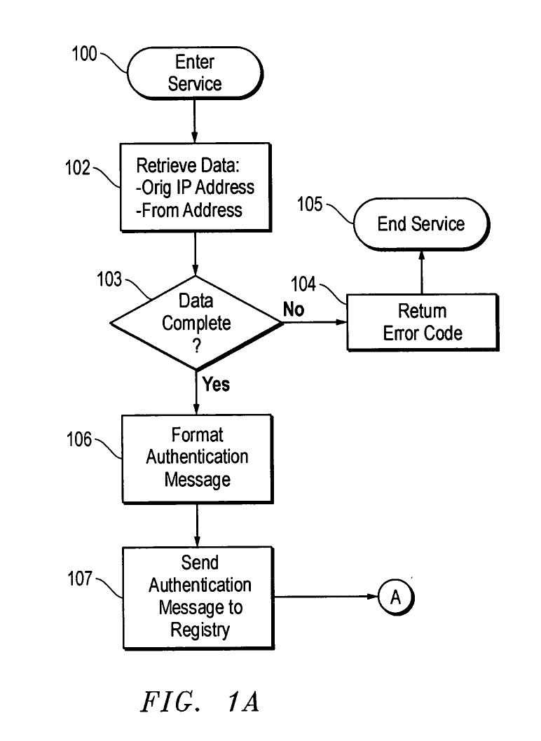

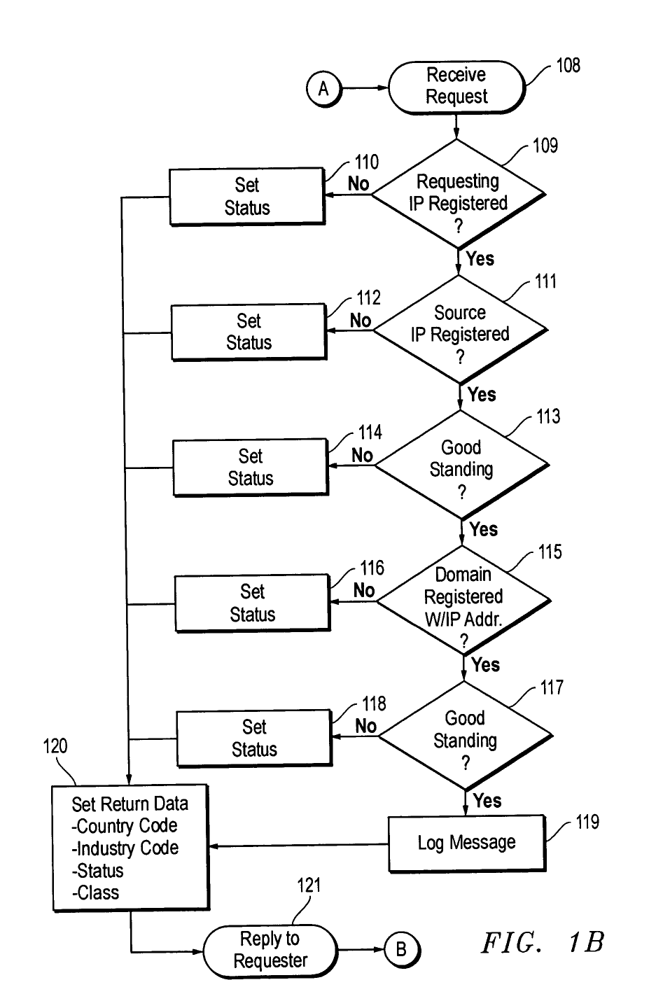

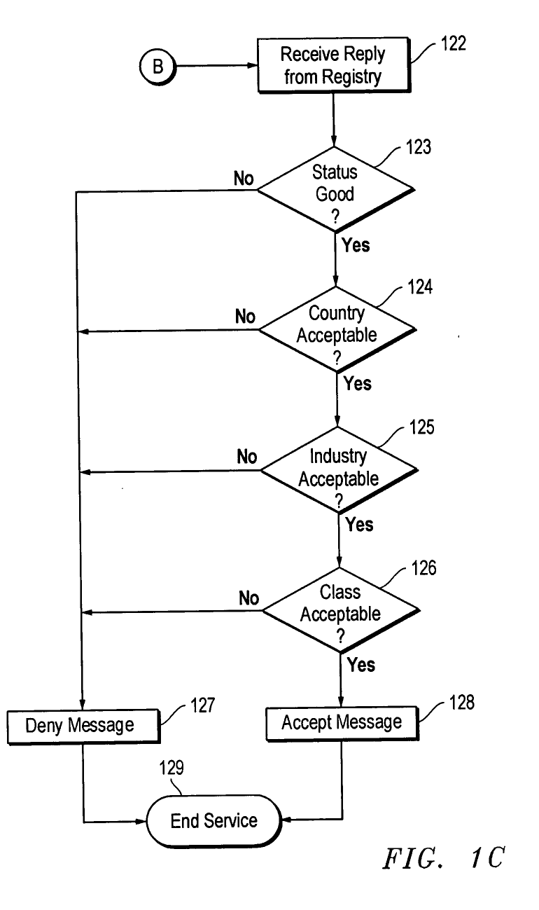

FIGS. 1A-1C are portions of a flow chart illustrating the steps of the preferred embodiment of the e-mail Registry method of the present invention. Referring to FIG. 1A, processes are shown that occur in an e-mail server or front-end computing resource. At step 100, an external e-mail server has contacted the Registry service to send an e-mail. The Registry receives the SMTP requests and at step 102, the message headers are interrogated to retrieve the server's IP address and the sender's domain. At step 103, it is determined whether the data is complete (i.e., both identifiers are available). If not, the test fails and the method moves to step 104 where then the e-mail message is rejected, an error code is returned, and the action is logged. At step 105, the method terminates the session with the source e-mail server, thus rejecting the message, and the Registry service is ended.

However, if the data is complete, the method moves from step 103 to step 106, where an authentication request message is formatted that includes the source e-mail server identification and domain. The message includes information that authenticates the receiving e-mail server as a member of the Registry. At step 107, the destination of the e-mail request is determined. If a local Registry image is on the e-mail server, or front-end computing resource, then an Application Programming Instruction (API) is executed to provide authentication. If not, then an authentication request message is sent using Secure Sockets Layer (SSL) to the Registry server(s) configured during program installation or ongoing maintenance. The method then moves to FIG. 1B, step 108.

FIG. 1B illustrates the steps performed by the Registry server upon receiving the authentication request message from the e-mail server or front-end computing resource. The Registry server may be local, or may be geographically distant from the e-mail server or front-end computing resource. At step 108, the authentication request is received at the Registry server, and the Registry authentication process begins, either local to the computing resource receiving the e-mail, or external and receiving the message as a “web service”. When the process is external and the “web service” access is used, it is important to note that the authenticating server could be anywhere on the Internet or on a private Intranet.

At step 109, the message source is tested using the source IP address to determine whether the authentication request originated from a registered e-mail server. The source IP address of the request message is checked against the Registry database to determine if the requesting e-mail server is registered. If not, the method moves to step 110 where an error code is set. The method then moves to step 120. However, if the requesting e-mail server is registered, the method moves from step 109 to step 111 where the IP address of the source e-mail server (i.e., the server that originated the incoming e-mail message), which was captured and sent from the requesting e-mail server, is checked against the Registry database to determine whether the source e-mail server is registered. If not, the method moves to step 112 where an error code is set. The method then moves to step 120.

However, if the IP address of the source e-mail server is registered, the method moves from step 111 to step 113 where it is determined whether the status of the source e-mail server's registration is in good standing. This status is used to suspend a registered server from the Registry. If the status is not “good”, the method moves to step 114 where an error code is set. The method then moves to step 120. However, if the status of the source e-mail server's registration is in good standing, the method moves from step 113 to step 115 where it is determined whether the domain from which the message originated (i.e., the source domain) is registered with the Registry as being associated with the IP address of the source e-mail server. If not, the method moves to step 116 where an error code is set. The method then moves to step 120.

However, if the source domain is registered as being associated with the source e-mail server, the method moves from step 115 to step 117 where it is determined whether the source domain's registration is in good standing. This status is used to suspend a registered domain from the Registry. If not, the method moves to step 118 where an error code is set. The method then moves to step 120. However, if the status of the source domain is in good standing, the method moves from step 117 to step 119 where the accepted e-mail is logged (i.e., recorded on a digital medium). Source, time of day, source address, and destination address are logged. The method then moves to step 120 where an authentication response message is formatted to include information regarding the domain (country code, industry code, status, and class). At step 121, the authentication response message is sent to the requesting e-mail server. The method then moves to FIG. 1C, step 122.

FIG. 1C illustrates the steps performed by the e-mail server or front-end computing resource upon receiving the authentication response message from the Registry server. At step 122, the authentication response message is received at the requesting e-mail server or front-end computing resource. The message may be checked for completeness, timeouts, and errors. If any errors are detected, the server flags the status of the authentication as “incomplete”, and logs the result in a notification log. At step 123, the status field in the authentication response message is tested. The status is compared to the user's desired action. If the status is incorrect, or if the response message is incomplete or contains errors, the method moves to step 127 where the incoming e-mail message is denied. However, if the status is good, or if the user has configured the software to allow unauthenticated or incomplete messages to continue, the method moves from step 123 to step 124 where it is determined whether the country code in the response message is acceptable. The country code from the e-mail source domain is compared against configuration parameters to determine if e-mails from this country are acceptable for the requesting e-mail server. If the country is not acceptable (i.e., blocked), the method moves to step 127 where the incoming e-mail message is denied. However, if the country code is acceptable, the method moves from step 124 to step 125 where it is determined whether the industry code in the response message is acceptable. The industry code from the e-mail source domain is compared against configuration parameters to determine if e-mails from this industry are acceptable for the requesting e-mail server. If the industry code is not acceptable, (i.e., blocked), the method moves to step 127 where the incoming e-mail message is denied.

However, if the industry code is acceptable, the method moves from step 125 to step 126 where it is determined whether the class code in the response message is acceptable. The class code from the e-mail source domain is compared against configuration parameters to determine if e-mails from this class are acceptable for the requesting e-mail server. If the class code is not acceptable, (i.e., blocked), the method moves to step 127 where the incoming e-mail message is denied. However, if the class code is acceptable, the method moves from step 126 to step 128 where basic information about the incoming e-mail message, such as for example, the source IP address, the source e-mail address, the destination e-mail address, the date, and the time, is logged. The incoming e-mail message is then delivered to the e-mail server that it is performing the front-end processing. The Registry service then ends at step 129.

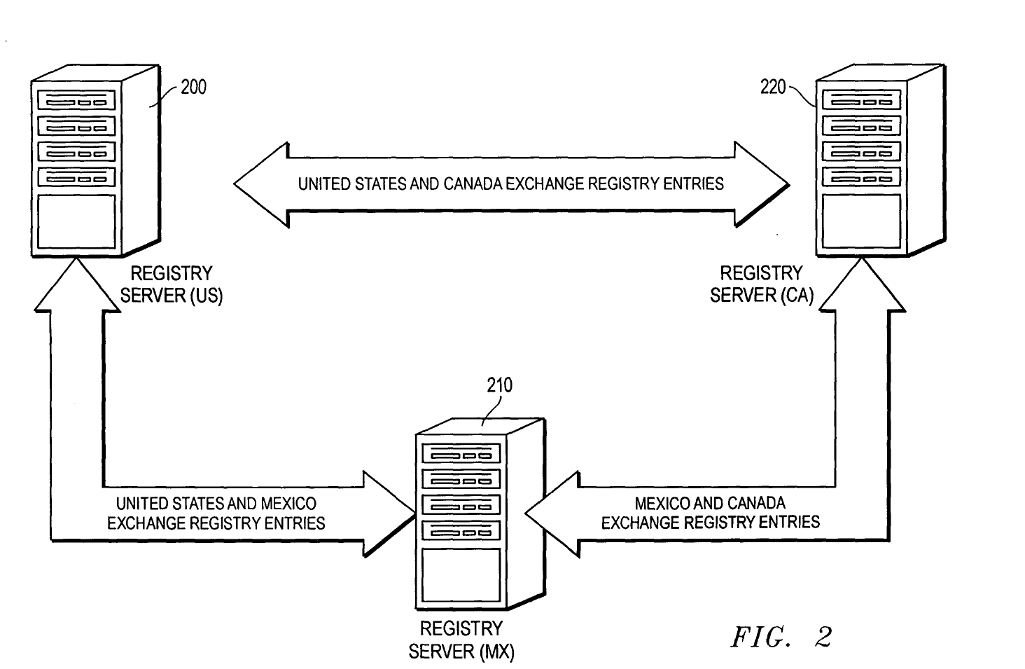

FIG. 2 is a simplified block diagram illustrating the communications between Registry servers primarily operating in different countries and exchanging Registry entries. A network is shown in which Registry servers 200, 210, and 220 share information over secure communication links using the Internet as the network. The Registry servers control entries for a specific country and then share that information with other Registry servers in other countries. As shown, Registry server 200 controls entries for the United States (US); Registry server 210 controls entries for Mexico (MX); and Registry server 220 controls entries for Canada (CA). The servers then share this information by transmitting entries to each other so that each Registry server remains current.

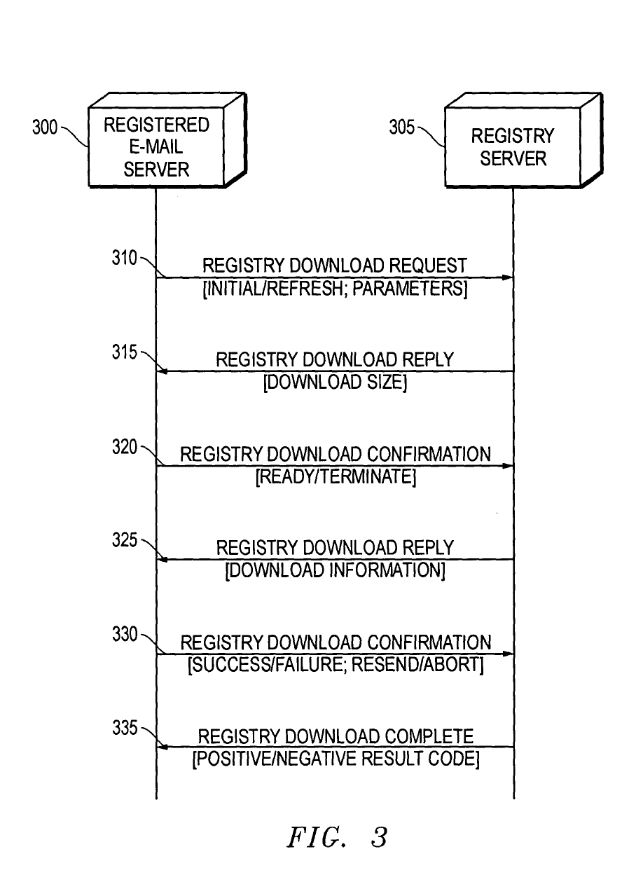

FIG. 3 is a message flow diagram illustrating the flow of messages between a registered e-mail server 300 and a Registry server 305 during download procedures to update the registered e-mail server's local directory of registered servers. This process enables private e-mail server environments to locally authenticate other e-mail servers that are sending e-mails to their servers. This process utilizes software-implemented processes at the Registry server and the private e-mail server environment. The registered e-mail server 300 may be, for example, a private corporate e-mail server or a government server or other certified e-mail server.

The registered e-mail server 300 first sends a Registry download request 310 to the Registry server environment 305. The download may be requested as an initial download or a refresh download. The request includes download parameters, which specify the last download date and time, desired countries, and the registered e-mail server's certification information. The Registry server receives the request message, authenticates the registered server, and sends a reply message 315 that provides information about the download session. This information may include, for example, how many entries are to be downloaded (deletes and insertions) and the total size of the download. The registered server receives the download reply message and saves the session information for validity checking at the end of the download. The registered server then sends a download confirmation message 320 back to the Registry server with an indication that the registered server is either ready for the download or has terminated the download due to resource restrictions. If the download has been terminated, the Registry server returns a download complete message, and the session is terminated.

If the confirmation message indicates that the registered server 300 is ready for the download, the Registry server 305 starts the download process by sending an initial or refresh Registry download reply message 325 containing initial information or updates to the registered server's local registry database. The downloaded information contains entries that have been either updated, added, or deleted since the registered server last completed a download, as indicated in the download request message 310. The registered server receives the download reply message and verifies that a complete transmission was received using a field that serves as a download validity check. The registered server then updates its local registry database with the information sent by the Registry server. The registered server then sends a download confirmation message 330 that includes an indication of the success or failure of processing the information in the download reply message 325. A second indicator field may be used to instruct the Registry server to either resend the download reply message or abort the download. If the download is aborted, the Registry server notes this fact in an operation log. If the download was successful, the Registry server verifies that the download has ended, and sends a download complete message 335 to the registered server. The download complete message may include a positive or negative result code and the date and time of the last entry.

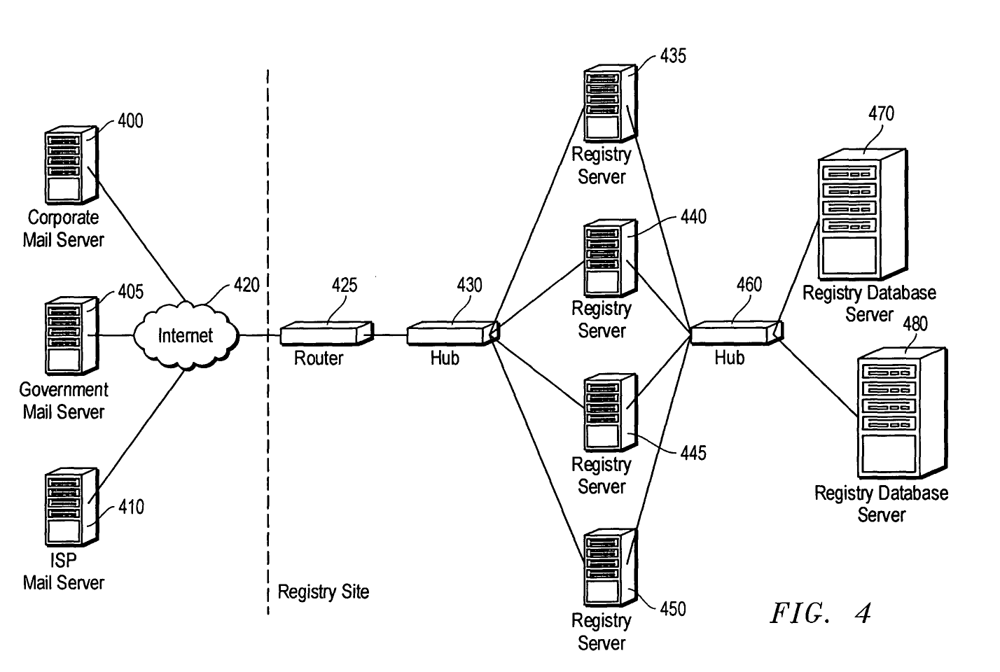

FIG. 4 is a simplified block diagram of networked e-mail servers 400, 405, and 410 accessing the Registry through the Internet 420. The e-mail servers may be corporate 400, government 405, or ISP 410 environments. These server environments are modified in accordance with the teachings of the present invention, and have Registry software installed on their e-mail servers or on front-end computers that relay registered e-mail to the e-mail servers. It should be noted that the network may be configured with more than one Registry site for fail safe processing. At the Registry site, router 425 is connected to the Internet, and provides access to and from the site. The router is connected to a hub 430, which is connected to a plurality of servicing Registry servers 435-450. It should be noted that a firewall may be installed between the router and the Registry servers.

Utilizing load balancing techniques, an available Registry server such as Registry server 440 may receive and process a request from one of the e-mail servers 400, 405, and 410 either to begin an upload process or for immediate certification of an e-mail message. There is no limit as to how many Registry servers may be installed at any specific site. Registry servers are added to sites as processing demand dictate. Requests for data are forwarded to Registry database servers 470 and 480 through a second network attached to the Registry servers via a second network card or hub 460. The second network further isolates the registry database servers. This decreases the likelihood that the database servers can be violated (hacked into). The database servers maintain the Registry of the e-mail servers and domains that have been registered in the Registry as a whole. Thus, all entries from over the globe are recorded in each Registry database server, and there are Registry database servers for each Registry site around the globe.

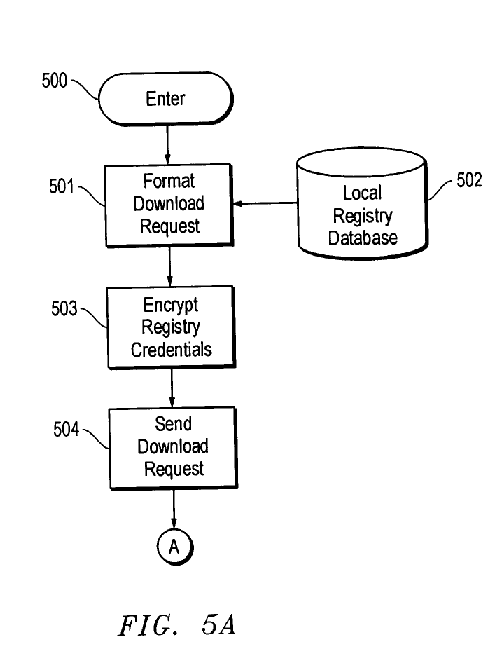

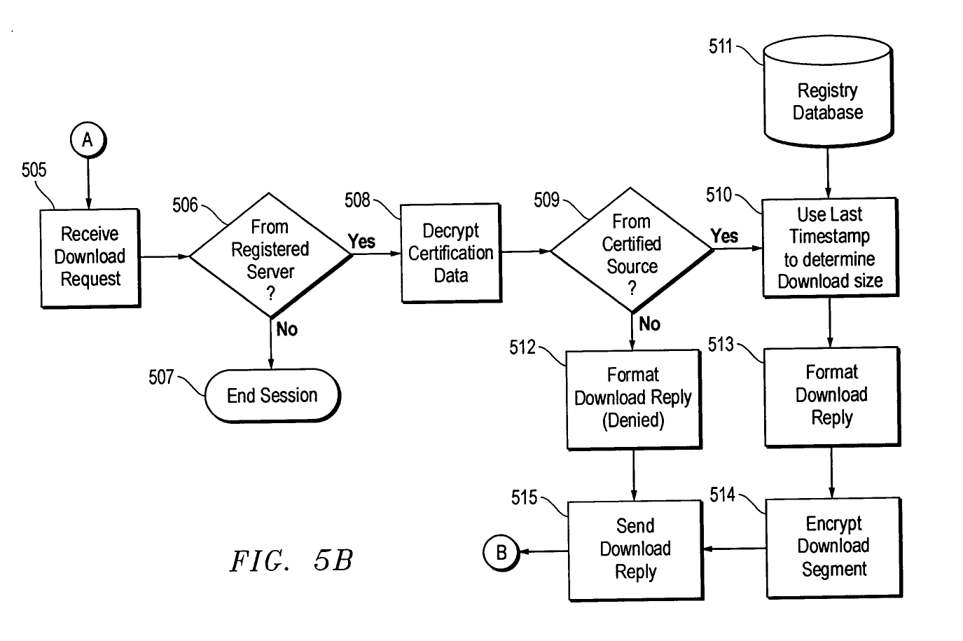

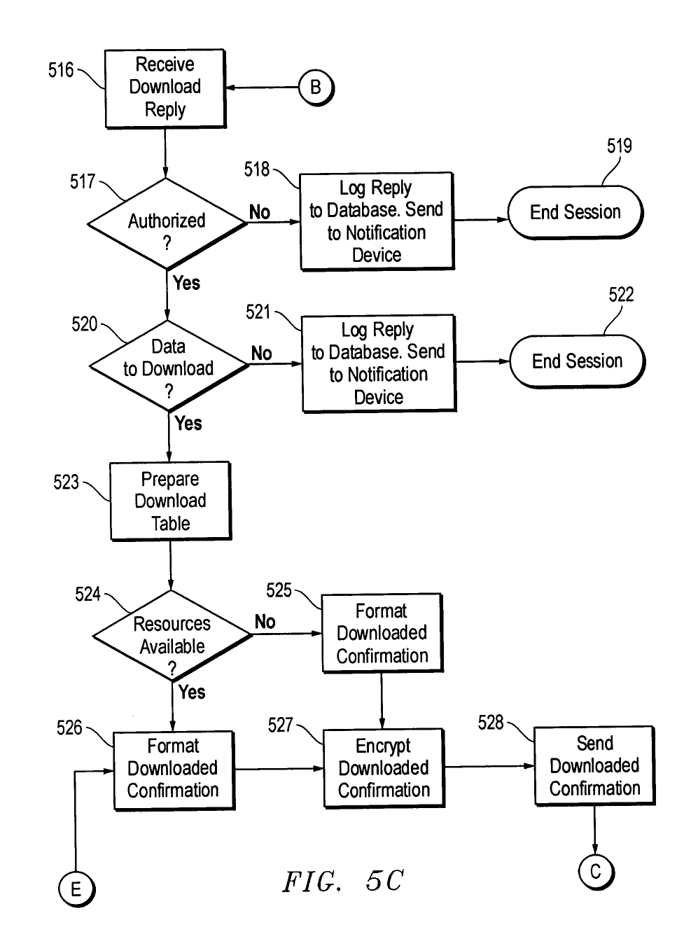

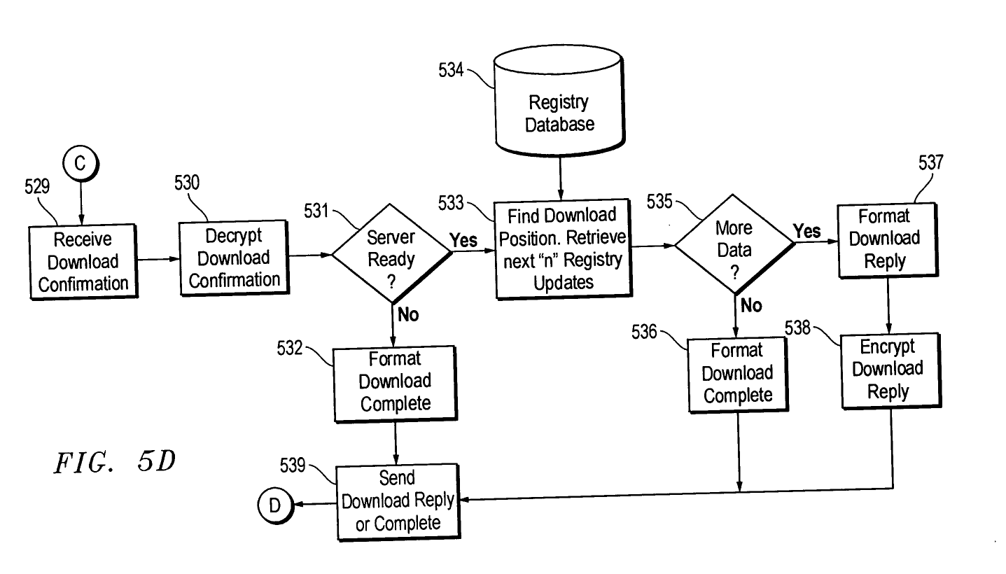

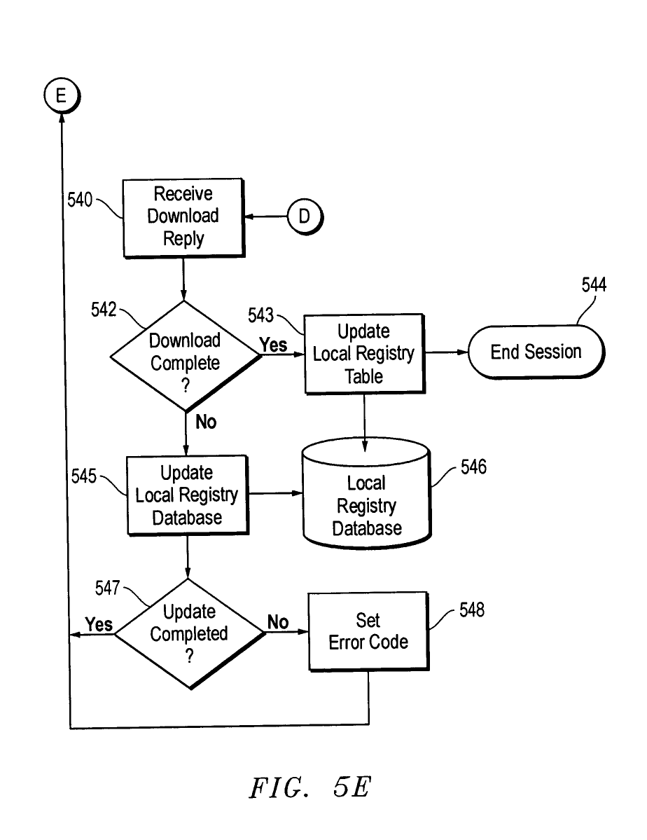

FIGS. 5A-5E are portions of a flow chart illustrating the download procedures between a Registry server and an e-mail server or another computer that provides a local registry database for processing. FIGS. 5A-5E illustrate the download process in further detail than FIG. 3. Descriptions are provided for the processes at each end, i.e., the e-mail server environment and the Registry confirmation environment. It is important to note that the architecture of the present invention allows several different configurations of the invention to be implemented. The method of the present invention, as illustrated in FIGS. 5A-5E, could occur on a single computer, or could involve a second computer that stores the local registry database and provides registry certification to one or more e-mail servers in the environment.

Referring to FIG. 5A, processes are shown that occur in an e-mail server or front-end computing resource. The method begins at step 500 when the e-mail server receives an incoming e-mail. At step 501, the e-mail server checks a local Registry database 502, and then formats a download request for the Registry. At step 503, the Registry certification data are encrypted, and at step 504, a download request message is sent to the Registry server. The method then moves to FIG. 5B, step 505.

Referring to FIG. 5B, processes are shown that occur in the Registry server. The Registry server receives the download request at step 505, and determines at step 506 whether the request is from a registered e-mail server. If not, the session is ended at step 507. If the request is from a registered server, the method moves from step 506 to step 508 where the Registry certification data are decrypted. At step 509, it is determined whether the source of the incoming e-mail is a certified source. If not, the method moves to step 512 and formats a download reply message denying the incoming e-mail. At step 515, this denial is sent back to the requesting e-mail server. However, if it is determined at step 509 that the source of the incoming e-mail is a certified source, the method moves instead to step 510 where updated Registry information is retrieved from the Registry database 511. The size of the download is determined utilizing the last timestamp for the requesting e-mail server. The method then moves to step 513 where a download reply message is formatted. The download segment is encrypted at step 514, and the download reply and updated Registry information are sent to the requesting e-mail server at 515. The method then moves to FIG. 5C, step 516.

Referring to FIG. 5C, processes are shown that occur in the requesting e-mail server or front-end computing resource. The requesting e-mail server receives the download reply message at step 516. At step 517, it is determined whether the reply message is authorized. If not, the method moves to step 518 where the reply is logged and sent to a notification device. The session then ends at step 519. However, if the reply message was authorized, the method moves from step 517 to step 520 where it is determined whether there is any data to download. If not, the method moves to step 521 where the reply is logged and sent to the notification device. The session then ends at step 522. However, if there is data to download, the method moves from step 520 to step 523 where a download table is prepared.

At step 524, the e-mail server determines whether it has sufficient resources available for the download. If not, a download confirmation failure message is formatted at step 525 indicating that the download is terminated. The confirmation failure is encrypted at step 527, and is sent to the Registry server at step 528 with an indication that the registered server has terminated the download due to resource restrictions. However, if it is determined that the e-mail server has sufficient resources available for the download, the method moves from step 524 to step 526 where a confirmation success message is formatted. The confirmation success is encrypted at step 527, and is sent to the Registry server at step 528 with an indication that the registered server is ready for the download. The method then moves to FIG. 5D, step 529.

Referring to FIG. 5D, processes are shown that occur in the Registry server upon receiving the download confirmation message. The Registry server receives the download confirmation message at step 529 and decrypts the message at step 530. At step 531, the Registry server determines from the indication in the confirmation message whether the requesting e-mail server is ready. If not, a download complete message is formatted at step 532, and the download complete message is returned to the requesting e-mail server at step 539. However, if it is determined that the requesting e-mail server is ready, the method moves from step 531 to step 533 where the Registry server finds the download position and retrieves the next “n” Registry updates from the Registry database 534.

At step 535, the Registry server determines whether there is more data to be downloaded. If not, a download complete message is formatted at step 536, and the download complete message is returned to the requesting e-mail server at step 539. However, if it is determined that there is more data to download, the method moves from step 535 to step 537 where a download reply message is formatted. The download reply message is encrypted at step 538, and is sent to the requesting e-mail server at step 539. The method then moves to FIG. 5E, step 540.

Referring to FIG. 5E, processes are shown that occur in the requesting e-mail server or front-end computing resource upon receiving the download complete or download reply message from the Registry server. The requesting e-mail server receives the message at step 540 and determines at step 542 whether the message is a download complete message. If so, the method moves to step 543 where the local Registry table and database 546 are updated. The method then ends at step 544. However, if the received message is not a download complete message, then it is a download reply message containing updated Registry information. The method moves to step 545 where the local Registry database is updated with the new Registry information. The method then determines at step 547 whether the update was completed. If complete, the method returns to step 526 (FIG. 5C) where a positive download confirmation message is formatted, and then encrypted and sent to the Registry server. If it is determined at step 547 that the update was not completed, the method moves to step 548 where an error code is set. The method then returns to step 526 (FIG. 5C) where a negative download confirmation message is formatted, and then encrypted and sent to the Registry server.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

1. A system for denying or allowing delivery of an incoming electronic mail (e-mail) message, said incoming message indicating a source e-mail server, a source domain, and an addressee for the message, said system comprising:
a central e-mail server registry database for storing information regarding all e-mail servers and domains authorized to send e-mail messages over the Internet;
means for the addressee to specify characteristics of domains that are authorized to send e-mail messages to the addressee;
means for an e-mail server serving the addressee to access information from the registry database to determine whether the source domain possesses the specified characteristics; and
means for allowing delivery of the incoming e-mail message if the source domain possesses the specified characteristics, and denying delivery of the incoming e-mail message if the source domain does not possess the specified characteristics.

2. The system of claim 1, wherein the information regarding all authorized e-mail servers and domains includes a status of each e-mail server's registration with the registry database, said status indicating whether each server is registered, whether the server's associated domains are registered, and whether the registrations are in good order.

3. The system of claim 2, wherein the means for allowing delivery and denying delivery of the incoming e-mail message includes means for denying delivery if the source domain is not registered, or if the registration of the source domain is not in good order.

4. The system of claim 2, wherein the means for allowing delivery and denying delivery of the incoming e-mail message includes means for denying delivery if the source domain is not associated with the source e-mail server.

5. The system of claim 2, wherein the information regarding all authorized e-mail servers and domains also includes a country code indicating a country of origin associated with each registered domain.

6. The system of claim 5, wherein the information regarding all authorized e-mail servers and domains also includes an industry code indicating an industry associated with each registered domain.

7. The system of claim 6, wherein the industry code is selected from industry codes defined by the North American Industry Classification System.

8. The system of claim 7, wherein the information regarding all authorized e-mail servers and domains also includes a class code indicating a type of business associated with each registered domain.

9. The system of claim 8, wherein the class code is selected from a group consisting of:
corporate business;
retail sales business;
corporate sales business;
corporate professional services business; and
consumer professional services business.

10. The system of claim 2, wherein the means for allowing delivery and denying delivery of the incoming e-mail message also includes means for denying delivery if the source e-mail server is not registered with the central registry database, or if the source e-mail server's registration is not in good standing.

11. The system of claim 10, further comprising:
a local registry database associated with the e-mail server serving the addressee for downloading predefined information from the central registry database;
means within the e-mail server serving the addressee for accessing the local registry database in a first attempt to determine whether the source e-mail server and/or source domain are registered in good standing, and whether the source domain possesses the specified characteristics; and
means within the e-mail server serving the addressee for accessing the central registry database in a second attempt to determine whether the source e-mail server and/or source domain are registered in good standing, and whether the source domain possesses the specified characteristics, said second attempt being made in response to determining that the source e-mail server and/or source domain are not registered in the local registry database.

12. A method of denying or allowing delivery of an incoming electronic mail (e-mail) message, said incoming message indicating a source e-mail server, a source domain, and an addressee for the message, said method comprising the steps of:
storing in a central e-mail server registry database, information regarding all e-mail servers and domains authorized to send e-mail messages over the Internet;
specifying for the addressee, characteristics of domains that are authorized to send e-mail messages to the addressee;
receiving the incoming e-mail in an e-mail server serving the addressee;
accessing by the e-mail server serving the addressee, information from the central registry database;
determining whether the source domain possesses the specified characteristics;
allowing delivery of the incoming e-mail message if the source domain possesses the specified characteristics; and
denying delivery of the incoming e-mail message if the source domain does not possess the specified characteristics.

13. The method of claim 12, wherein the step of specifying for the addressee, characteristics of domains that are authorized to send e-mail messages to the addressee includes specifying authorized countries of origin, authorized industries, and authorized classes of businesses from which e-mail messages are to be delivered to the addressee.

14. The method of claim 12, further comprising denying delivery of the incoming e-mail message if the source e-mail server is not registered in the central registry database.

15. The method of claim 12, further comprising denying delivery of the incoming e-mail message if the source domain is not registered in the central registry database.

16. The method of claim 12, further comprising denying delivery of the incoming e-mail message if the information in the central registry database indicates that the source e-mail server and/or source domain do not have a registration in good standing.

17. The method of claim 12, further comprising denying delivery of the incoming e-mail message if the source domain is not associated with the source e-mail server.

18. The method of claim 12, further comprising, before receiving the incoming e-mail, the steps of:
downloading from the central registry database to the e-mail server serving the addressee, predefined information from the registry database; and
storing the downloaded information in a local registry database associated with the e-mail server serving the addressee.

19. The method of claim 18, further comprising, after receiving the incoming e-mail, the steps of:
accessing by the e-mail server serving the addressee, the local registry database in a first attempt to determine to determine whether the source e-mail server and/or source domain are registered in good standing, and whether the source domain possesses the specified characteristics; and
if the source e-mail server and/or source domain are not registered in the local registry database, accessing by the e-mail server serving the addressee, the central registry database in a second attempt to determine whether the source e-mail server and/or source domain are registered in good standing, and whether the source domain possesses the specified characteristics.

20. The method of claim 18, further comprising periodically refreshing the downloaded information in the local registry database.

21. The method of claim 18, further comprising refreshing the downloaded information in the local registry database when requested by the e-mail server serving the addressee.

22. An e-mail server registry comprising:
means for registering e-mail servers and domains authorized to send e-mail messages over the Internet;
an e-mail server registry database for storing information regarding the registered e-mail servers and domains; and
means for responding to queries from registered e-mail servers regarding other e-mail servers and/or domains.

23. The e-mail server registry of claim 22, wherein the e-mail server registry database stores information regarding the registration status of each registered e-mail server and domain, and information regarding each registered domain's country, industry, and business class.

24. The e-mail server registry of claim 23, further comprising:
means for receiving a complaint from a registered e-mail server regarding an identified source e-mail server sending an e-mail with characteristics that do not match the registered information regarding the country, industry, or business class of the e-mail's domain; and
means for suspending the identified source e-mail server from the registry upon determining that the source e-mail server is sending e-mails with characteristics that do not match the registered information regarding the countries, industries, or business classes of the source e-mail server's registered domains.

25. The e-mail server registry of claim 24, further comprising means for changing the registration status of the identified source e-mail server from “good” to “review” after receiving the complaint, and while determining whether the source e-mail server is sending e-mails with characteristics that do not match the registered information regarding the countries, industries, or business classes of the source e-mail server's registered domains.

26. The e-mail server registry of claim 22, wherein the means for responding to queries includes means for determining whether an identified e-mail server and/or domain is registered, whether the identified e-mail server and/or domain is registered in good standing, and whether the identified domain possesses defined characteristics regarding the country, industry, and business class of the identified domain.

27. The e-mail server registry of claim 22, wherein the means for responding to queries includes means for verifying that an identified domain is properly associated with an identified e-mail server.

28. A system for denying or allowing delivery of an incoming electronic mail (e-mail) message, said incoming message indicating a source e-mail server and an addressee for the message, said system comprising:
a central e-mail server registry database for storing registration information for all e-mail servers authorized to send e-mail messages over the Internet;
means for an e-mail server serving the addressee to query the registry database to determine whether the source e-mail server is registered in the registry database; and
means for allowing delivery of the incoming e-mail message if the source e-mail server is registered in the registry database, and denying delivery of the incoming e-mail message if the source e-mail server is not registered in the registry database.

29. The system of claim 28, wherein the central e-mail server registry database also stores an indication for each e-mail server indicating whether each server's registration is in good standing, and the means for allowing delivery and denying delivery of the incoming e-mail message also includes means for denying delivery if the source e-mail server's registration is not in good standing.

30. The system of claim 28, wherein the central e-mail server registry database only responds to queries from registered e-mail servers

31. A system for denying or allowing delivery of an incoming electronic mail (e-mail) message, said incoming message indicating a source e-mail server, a source domain, and an addressee for the message, said system comprising:
an e-mail server serving the addressee;
a local e-mail server registry database associated with the e-mail server serving the addressee, said local registry database storing information for a subset of all e-mail servers and domains authorized to send e-mail messages over the Internet;
means for the addressee to specify characteristics of domains that are authorized to send e-mail messages to the addressee;
means for the e-mail server serving the addressee to access information from the local registry database to determine whether the source domain possesses the specified characteristics; and
means within the e-mail server serving the addressee for allowing delivery of the incoming e-mail message if the source domain possesses the specified characteristics, and denying delivery of the incoming e-mail message if the source domain does not possess the specified characteristics, or if the source domain is not included in the local registry database.

32. The system of claim 31, wherein the subset of all e-mail servers and domains includes a subset of domains selected from a group consisting of:
all domains having a specified country code;
all domains having a specified industry code; and
all domains having a specified business class.
